(19) United States
(12) Patent Application Publication
(10) Pub. No.: US 2020/0387691 A1
(43) Pub. Date: Dec. 10, 2020

(54) A QUICK MATCH ALGORITHM FOR BIOMETRIC DATA

(71) Applicant: PRECISE BIOMETRICS AB, Lund (SE)

(72) Inventor: Fredrik ROSQVIST, Malmö (SE)

(73) Assignee: PRECISE BIOMETRICS AB, Lund (SE)

(21) Appl. No.: 16/463,936

(22) PCT Filed: Nov. 23, 2017
(86) PCT No.: PCT/EP2017/080251

§ 371 Date: May 24, 2019

(30) Foreign Application Priority Data
Nov. 24, 2016 (SE) 1651535-5

(51) Int. Cl. G06K 9/00; G06K 9/62; G06K 9/46

(52) U.S. Cl. CPC G06K 9/00087; G06K 9/4642; G06K 9/6215

(57) ABSTRACT

A method (10) for matching a biometric user template to at least one multi template is provided. Each multi template is formed by a group of sub templates each representing an area of an associated biometric object of a person. The method comprises a) determining (11) a first matching score between at least one of the sub templates for at least one of the multi-templates and the user template; b) determining (12) an order of the sub templates based on their first matching score and which multi template they belong to; c) processing (13) at least one of the sub templates successively based on the predetermined order, wherein said processing comprises for each sub template: d) determining (131) a second matching score between the sub template and the user template, e) comparing (132) the second matching score to a threshold score, and g) generating (133) a signal indicating a match if the second matching score is above the threshold score.

### TECHNICAL FIELD

The present invention generally relates to a method for matching a biometric user template to at least one multi template.

### BACKGROUND

Use of small biometric sensors, i.e. sensors that do not collect biometric data about the whole biometric object, may be desired due to constraints caused by e.g. physical design of an apparatus used to collect the biometric data. Due to the small size of the biometric sensor in view of the whole biometric object, e.g. a fingerprint, normally several biometric templates, which may also be referred to as sub templates, are required to be stored or reconstructed as reference or multi-template data for subsequent matching.

While matching accuracy is of high importance, there is a need to speed up the matching performance, especially when each multi template comprises a large number of sub templates or in the case where several reference multi-templates are stored on the electronic device. Current electronic devices, such as smart phones, allow for storing several biometric references, i.e. multi templates, e.g. each relating to a fingerprint of a finger of a user. Such electronic devices may allow for multiple users to access the electronic device via biometric matching. Accordingly, each electronic device may have multi templates relating to biometric data of one or more fingers of each user. Thus, several multi-templates may be stored on the electronic device, all of which are used in the subsequent matching.

There is an urge to perform the subsequent matching as quickly as possible. When several biometric references are available current matching processes may take a long time until either a match or no match indication signal is generated.

Hence, it would be advantageous to provide an improved method of matching a biometric user template to at least one biometric multi-template.

### SUMMARY

An object of the invention is to at least alleviate the above stated problem. A general solution is to provide a two stage matching method in order to speed up the overall matching process.

According to an aspect a method for matching a biometric user template to at least one multi template is provided. Each multi template is formed by a group of sub templates each representing an area of an associated biometric object of a person. The method comprises
a) determining a first matching score between at least one of the sub templates for at least one of the multi-templates and the user template;
b) determining an order of the sub templates based on their first matching score and which multi template they belong to;
c) processing at least one of the sub templates successively based on the predetermined order, wherein said processing comprises for each sub template:
   d) determining a second matching score between the sub template and the user template,
   e) comparing the second matching score to a threshold score, and
   f) generating a signal indicating a match if the second matching score is above the threshold score.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings.

FIG. 1 is a flow chart schematically illustrating a method of updating reference biometric data; and

FIG. 2 is a flow chart schematically illustrating an alternative method of updating reference biometric data.

### DETAILED DESCRIPTION

As is widely known, a biometric template contains information associated with a biometric object, and form a digital reference of distinct characteristics, e.g. minutia points, etc, that have been extracted from a biometric object. Accordingly, a biometric template does not have to contain all of the biometric information of the biometric object, but instead a reduced amount of biometric information of the object may be contained in each template.

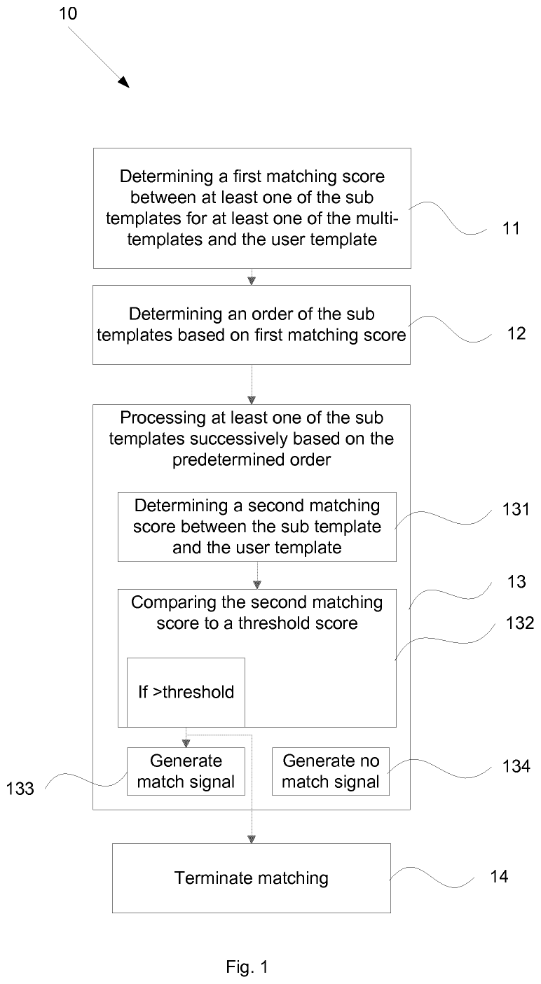

An aim of the present invention is to speed up the matching process, e.g. for authentication purposes, for any solution utilizing a number of reference templates to be matched with a biometric user template, without requiring more computational power. FIG. 1 shows a flow chart of a method for matching a biometric user template to at least one multi template. Each multi template is formed by a group of sub templates each representing or being associated with an area of an associated biometric object of a person. In this way, since the multi template comprises more than one sub template, the multi template represents or is associated with an area of the associated biometric object being larger than each of the sub templates.

The method comprises a) determining 11 a first matching score between at least one of the sub templates for at least one of the multi-templates and the user template. The method further comprises b) determining 12 an order of the sub templates based on their first matching score and which multi template they belong to.

Accordingly, the sub templates may be ordered such that the ones with the highest scores are selected for subsequent processing first. The method further comprises c) processing 13 at least one of the sub templates successively based on the predetermined order. The processing comprises for each sub template: d) determining 131 a second matching score between the sub template and the user template, e) comparing 132 the second matching score to a threshold score, and g) generating 133 a signal indicating a match if the second matching score is above the threshold score.

The method may further comprise terminating 14 the matching if a second matching score is above the threshold score.

The first matching score is determined using a first matching algorithm and the second matching score is determined using a second matching algorithm. The first matching algorithm is less complex than that of the second matching algorithm.

The first matching score may be determined by:

creating a first histogram of the direction field of the user template,

creating a second histogram of the direction field of the candidate sub template, and

comparing the first and second histogram to determine a first matching score based on the similarity of said histograms.

The second matching algorithm may relate to any conventional matching algorithm providing matching with a high accuracy. In other words, the second matching algorithm need to meet false acceptance requirements, such as to keep the false acceptance rate (FAR) at or below any accepted level. The FAR is the measure of the likelihood that the biometric security system will incorrectly accept an access attempt by an unauthorized user. Normally, the FAR is stated as the ratio of the number of false acceptances divided by the number of identification attempts.

Conventional matching algorithms attempt to match each sub template using such a second matching algorithm. However, in order to meet the FAR requirements, this is very computational intensive, whereby it takes a lot of time to process all sub templates using this second matching algorithm.

The present inventor has realized that by performing a pre-matching using a less computational intensive algorithm, not being bound by any FAR requirement, it is possible to identify sub templates most likely to result in a match with the subsequent second matching algorithm, and process these first with the second matching algorithm. In this way it is more likely that a successful match (using the second matching algorithm) will occur quicker than using the conventional approach.

Normally each multi template comprises a plurality of sub templates.

The determined order of the sub templates is preferably such that the sub template with the highest first matching score is placed first for the subsequent determination for of the second matching score.

The determined order of the sub templates may also be such that the sub templates with the highest first matching scores are placed in descending order for processing.

It should be appreciated that the present invention is not limited to only one multi template. Rather, the method is very suitable for applications where more than one multi templates are used. Each multi template may relate to biometric data relating to one fingertip of a certain user. Accordingly, for each user several multi templates may be stored, one for each finger. The number of multi templates is thus based on the number of fingertips stored for each user, and the number of users. As an example, the number of multi templates used in the method may e.g. be 10, of which 5 multi templates relate to different fingertips of one user, wherein 3 multi templates relate to fingertips of a second user, and 2 multi templates relate to fingertips of a third user.

The determined order of the sub templates may be such that the sub template with the highest first matching score for each multi-template is placed in descending order for processing. This means that the sub template for each multi template having the highest first score is selected for processing first. If no match is detected during processing using steps 131 to 133 for the sub template having the highest first matching score, the sub template having the next highest first matching score is selected or processing in steps 131 to 133, and so on.

The determined order of the sub templates is such that the sub templates are placed in successive groups based on their first matching score in a descending order for processing, wherein each group comprising one sub template of each multi-template. This also means that the sub template for each multi template having the highest first score is selected for processing first. Once the sub templates having the highest first matching scores of all multi templates have been processed in steps 131 to 133, the sub template of each multi template having the second highest first matching score is processed in steps 131 to 133.

The overall time reduction in finding a match is greatly increased compared to prior art solutions when the number of multi-templates increase, since the second matching score is conducted one sub template of one multi template at a time, wherein said sub template has the highest first matching score for the associated multi template. In this way, once a second matching score has been calculated for a first sub template (identified based on its first matching score) of a first multi template, a second matching score of the first sub template (identified based on its first matching score) of a second multi template may be executed. In this way the most promising sub template (identified based on the first matching score) for each multi template may be processed in steps 131 to 133 before the next most promising sub template for each multi template is processed in steps 131 to 133.

The order in which a particular sub template of one multi template is selected for processing may be based on a sorting process where the sub template for each multi template, having the highest first matching score, is compared to the sub template of each other multi template having the highest first matching score. Essentially, the sorting process identifies the order for each multi template of the group, based on the first matching score of each sub template contained in the group. Accordingly, before the processing according to steps 131 to 133 is conducted for the sub templates of a first group the sorting process may identify the order in which the sub templates of said group is to be processed. If no match is found for any sub template of the first group, the sorting process may sort the sub templates of a second group containing one sub template for each multi template having the second highest first matching score. The sorting process is associated with the predetermined order. Hence, the predetermined order of processing may be based on such sorting process, including the optional grouping of sub templates into groups as described herein. Naturally, the predetermined order may only be derived once so that no sorting has to be done during the processing steps of the groups of sub templates. However, in some application it could be advantageous to determine the order of the processing on the fly, i.e. after one group has been processed and before the next is to be processed.

In the table below, the predetermined order is such that the sub templates are placed in successive groups based on their first matching score in a descending order for processing. Consequently, one sub template having the highest first matching score for each multi template is put in a first group, the sub templates having the second highest first matching scores for each multi template is put in a second group etc.

| | Multi template | Multi template | Multi template |
|---|---|---|---|
| | No. 1 (M1) | No. 2 (M2) | No. 3 (M3) |
| Group 1 (Highest | 0.8 | 0.9 | 0.7 |
| first matching | | | |
| score) - G1 | | | |
| Group 2 (Second | 0.75 | 0.73 | 0.69 |
| highest matching | | | |
| score) - G2 | | | |
| Group 3 (Third | 0.65 | 0.67 | 0.68 |
| highest matching | | | |
| score) - G3 | | | |

Once the groups have been identified based on the first matching score, the sorting process may identify the order in which each sub template of a group is to be processed in steps 131, 132.

In the above case, such a sorting process could identify the following order for processing:

G1M2 (0.9) then G1M1 (0.8) then G1M3 (0.7) then G2M1 (0.75) then G2M2 (0.73) then G2M3 (0.69) then G3M3 (0.68) then G3M2 (0.67) then G3M1 (0.65). Accordingly, the sub templates of the first groups are processed before the sub templates of the second groups are processed. However, the order in which each sub template of a multi template relating to a particular group is processed relate to the highest first matching score within the group.

It should be appreciated that depending on the first matching score a group may not be represented by all of the available multi templates, especially if the first matching score of a sub template of a certain multi template is below a threshold score. In this way, sub templates for multi templates not meeting the minimum threshold score may be discarded from each group. For example, if the minimum threshold score would be set to 0.66, then G3M1 (0.65) would be discarded from Group 3 above and the order of processing would be:

G1M2 (0.9) then G1M1 (0.8) then G1M3 (0.7) then G2M1 (0.75) then G2M2 (0.73) then G2M3 (0.69) then G3M3 (0.68) then G3M2 (0.67).

When the determined order is such that the sub template with the highest first matching score for each multi-template is placed in descending order for processing, the determined order is independent of any groups. For the example above, the order of processing would be:

G1M2 (0.9) then G1M1 (0.8) then G2M1 (0.75) then G2M2 (0.73) then G1M3 (0.7) then G2M3 (0.69) then G3M3 (0.68) then G3M2 (0.67) then G3M1 (0.65).

The method may further comprise generating 134 a signal indicating no match when a predetermined number of sub templates have been processed and no signal indicating a match has been generated.

Alternatively the method may further comprise generating 134 a signal indicating no match when a predetermined number of sub templates of each multi template have been processed and no signal indicating a match has been generated. This ensures that an equal amount of matching attempts have been made for each multi template.

The method may further comprise generating 134 a signal indicating no match when a predetermined processing time period has lapsed and no signal indicating a match has been generated.

The method may further comprise terminating the matching in connection with generating the signal indicating no match.

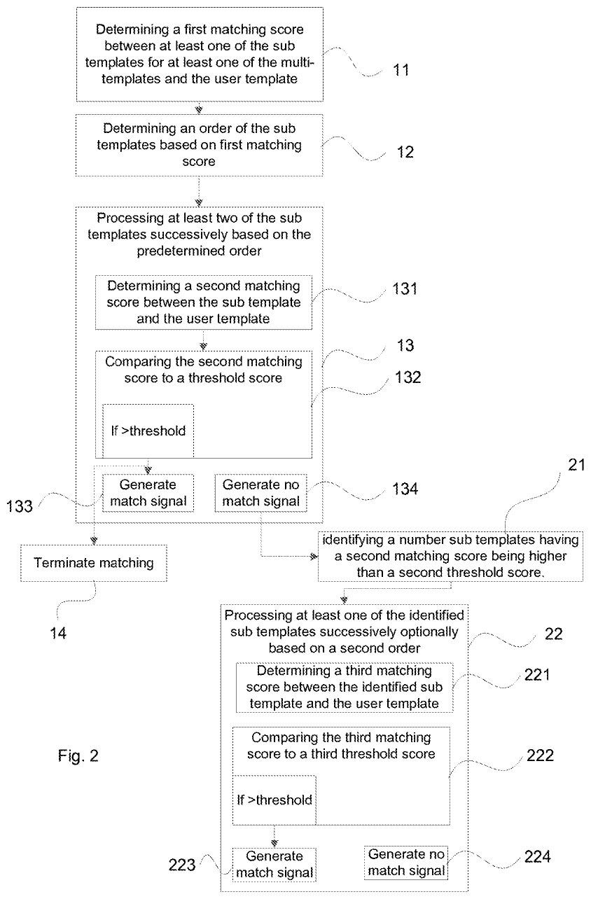

With reference to FIG. 2, in response to the signal indicating no match the method may further comprise identifying 21 a number sub templates having a second matching score being higher than a second threshold score. The identified number of sub templates thus respectively have a second matching score being less than a threshold required for a match but still higher than a second threshold score, which makes the identified sub templates candidates for a further matching algorithm.

Accordingly, the method may comprise processing 22 at least one of the identified sub templates successively, wherein said processing comprises for each sub template:
determining 221 a third matching score between at least one of the identified sub templates and the user template,
comparing 222 the third matching score to a third threshold score, and
generating 223 a signal indicating a match if the third matching score is above the third threshold score.

Optionally the identified sub templates may be ordered, according to a second order, such that the most promising sub template of the identified sub templates is selected first for the processing.

Accordingly, the processing 22 may be conducted for at least one identified sub template according to a determined second order, wherein the determined second order is such that the identified sub template with the highest second matching score is placed first for the processing 22.

The third matching score may be determined using a third matching algorithm being more complex than a second matching algorithm used for determining the second matching score. It will thus take longer time to process a certain sub template using the third matching algorithm than using the second matching algorithm. Accordingly, the third matching algorithm may be more accurate in finding a match than that of the second matching algorithm, however at the expense of time.

For the purpose of keeping the overall time consumption of the matching process to a minimum it is an aim to keep the number of identified sub templates eligible for a third matching to a minimum, such as to keep the matching process as time efficient as possible, however while still allowing for a match between a sub template and a user template to be made.

The determined second order of the identified sub templates may also be such that the identified sub templates with the highest second matching scores are placed in descending order for processing.

Alternatively, the determined second order of the indentified sub templates may also be such that the identified sub template with the highest second matching score for each multi-template is placed in descending order for processing.

The method may further comprise generating 224 a signal indicating no match when a predetermined number of indentified sub templates have been processed and no signal indicating a match has been generated.

Alternatively the method may further comprise generating 224 a signal indicating no match when a predetermined number of sub templates of each multi template have been processed and no signal indicating a match has been generated. This ensures that an equal amount of matching attempts have been made for each multi template.

The method may further comprise generating 224 a signal indicating no match when a predetermined processing time period has lapsed and no signal indicating a match has been generated.

1.-16. (canceled)

17. A method for matching a biometric user template to at least one multi template, wherein each multi template is formed by a group of sub templates each representing an area of an associated biometric object of a person, the method comprising:
a) determining a first matching score between at least one of the sub templates for at least one of the multi templates and the user template;
b) determining an order of the sub templates based on their first matching score and which multi template they belong to; and
c) processing at least one of the sub templates successively based on the determined order, wherein the processing involves for each sub template,
d) determining a second matching score between the sub template and the user template,
e) comparing the second matching score to a threshold score, and
f) generating a signal indicating a match if the second matching score is above the threshold score.

18. The method according to claim 17, further comprising:
terminating the matching if a second matching score is above the threshold score.

19. The method according to claim 17, wherein the determined order of the sub templates is such that the sub template with the highest first matching score is placed first for the processing.

20. The method according to claim 17, wherein the determined order of the sub templates is such that the sub templates with the highest first matching scores are placed in descending order for the processing.

21. The method according to claim 17, wherein the determined order of the sub templates is such that the sub template with the highest first matching score for each multi-template is placed in descending order for the processing.

22. The method according to claim 17, wherein the determined order of the sub templates is such that the sub templates are placed in successive groups based on their first matching score in a descending order for the processing, wherein each group includes one sub template of each multi template.

23. The method according to claim 17, wherein the processing further comprises:
generating a signal indicating no match when a predetermined number of sub templates have been processed and no signal indicating a match has been generated.

24. The method according to claim 17, wherein the processing further comprises:
generating a signal indicating no match when a predetermined number of sub templates of each multi template have been processed and no signal indicating a match has been generated.

25. The method according to claim 17, wherein the processing further comprises:
generating a signal indicating no match when a predetermined processing time period has lapsed and no signal indicating a match has been generated.

26. The method according to claim 23, further comprising:
terminating the matching in connection with generating the signal indicating no match.

27. The method according to the claim 23, further comprising:
in response to the signal indicating no match,
identifying a number of sub templates having a second matching score being higher than a second threshold score;
processing (22) at least one of the identified sub templates successively, wherein the processing (22) involves for each sub template,
determining a third matching score between at least one of the identified sub templates and the user template,
comparing the third matching score to a third threshold score, and
generating a signal indicating a match if the third matching score is above the third threshold score.

28. The method according to claim 27, wherein the processing (22) is conducted for at least one identified sub template according to a determined second order; and
wherein the determined second order is such that the identified sub template with the highest second matching score is placed first for the processing (22).

29. The method according to claim 17, wherein the first matching score is determined using a first matching algorithm and the second matching score is determined using a second matching algorithm.

30. The method according to claim 29, wherein the first matching algorithm is less complex than that of the second matching algorithm.

31. The method according to claim 29, wherein the first matching algorithm is associated with,
creating a first histogram of the direction field of the user template,
creating a second histogram of the direction field of a candidate sub template, and
comparing the first and the second histograms to determine a first matching score based on the similarity of the histograms.

32. The method according to claim 27, wherein the third matching score is determined using a third matching algorithm being more complex than a second matching algorithm used for determining the second matching score.
